(19) United States
(12) Patent Application Publication
(10) Pub. No.: US 2019/0236718 A1
(43) Pub. Date: Aug. 1, 2019

(54) SKILLS-BASED CHARACTERIZATION AND COMPARISON OF ENTITIES

(71) Applicant: Microsoft Technology Licensing, LLC, Redmond, WA (US)

(72) Inventors: Sarah Rastkar, San Francisco, CA (US); Erik M. Knoll, San Francisco, CA (US); Alan Fritzler, San Francisco, CA (US)

(73) Assignee: Microsoft Technology Licensing, LLC, Redmond, WA (US)

(21) Appl. No.: 15/885,149

(22) Filed: Jan. 31, 2018

(51) Int. Cl. G06Q 50/00; H04L 29/08; G06F 17/30

(52) U.S. Cl. CPC G06Q 50/01; G06F 17/30412; G06F 17/30867; H04L 67/306

(57) ABSTRACT

The disclosed embodiments provide a system for processing data. During operation, the system obtains a grouping of entities by one or more attributes. Next, the system calculates, from counts of skills in the entities, a skill vector for the grouping of entities, wherein the skill vector includes a set of scores representing a prevalence of a set of skills in the grouping. The system then analyzes the set of scores in the skill vector to characterize the grouping with respect to the set of skills. Finally, the system outputs a result of the analyzed set of scores.

### BACKGROUND

### Field

The disclosed embodiments relate to techniques for performing skills-based characterization and comparison of entities.

### Related Art

Online networks may include nodes representing entities such as individuals and/or organizations, along with links between pairs of nodes that represent different types and/or levels of social familiarity between the entities represented by the nodes. For example, two nodes in an online network may be connected as friends, acquaintances, family members, and/or professional contacts. Online networks may further be tracked and/or maintained on web-based networking services, such as online professional networks that allow the entities to establish and maintain professional connections, list work and community experience, endorse and/or recommend one another, run advertising and marketing campaigns, promote products and/or services, and/or search and apply for jobs.

In turn, users and/or data in online professional networks may facilitate other types of activities and operations. For example, sales professionals may use an online professional network to locate prospects, maintain a professional image, establish and maintain relationships, and/or engage with other individuals and organizations. Similarly, recruiters may use the online professional network to search for candidates for job opportunities and/or open positions. At the same time, job seekers may use the online professional network to enhance their professional reputations, conduct job searches, reach out to connections for job opportunities, and apply to job listings. Consequently, use of online professional networks may be increased by improving the data and features that can be accessed through the online professional networks.

### BRIEF DESCRIPTION OF THE FIGURES

FIG. 1 shows a schematic of a system in accordance with the disclosed embodiments.

FIG. 2 shows a system for processing data in accordance with the disclosed embodiments.

FIG. 3 shows the calculation of a skill vector for a grouping of entities in accordance with the disclosed embodiments.

FIG. 4 shows a flowchart illustrating the processing of data in accordance with the disclosed embodiments.

FIG. 5 shows a flowchart illustrating a process of calculating a skill vector for a grouping of entities in accordance with the disclosed embodiments.

FIG. 6 shows a computer system in accordance with the disclosed embodiments.

In the figures, like reference numerals refer to the same figure elements.

### DETAILED DESCRIPTION

The following description is presented to enable any person skilled in the art to make and use the embodiments, and is provided in the context of a particular application and its requirements. Various modifications to the disclosed embodiments will be readily apparent to those skilled in the art, and the general principles defined herein may be applied to other embodiments and applications without departing from the spirit and scope of the present disclosure. Thus, the present invention is not limited to the embodiments shown, but is to be accorded the widest scope consistent with the principles and features disclosed herein.

The data structures and code described in this detailed description are typically stored on a computer-readable storage medium, which may be any device or medium that can store code and/or data for use by a computer system. The computer-readable storage medium includes, but is not limited to, volatile memory, non-volatile memory, magnetic and optical storage devices such as disk drives, magnetic tape, CDs (compact discs), DVDs (digital versatile discs or digital video discs), or other media capable of storing code and/or data now known or later developed.

The methods and processes described in the detailed description section can be embodied as code and/or data, which can be stored in a computer-readable storage medium as described above. When a computer system reads and executes the code and/or data stored on the computer-readable storage medium, the computer system performs the methods and processes embodied as data structures and code and stored within the computer-readable storage medium.

Furthermore, methods and processes described herein can be included in hardware modules or apparatus. These modules or apparatus may include, but are not limited to, an application-specific integrated circuit (ASIC) chip, a field-programmable gate array (FPGA), a dedicated or shared processor that executes a particular software module or a piece of code at a particular time, and/or other programmable-logic devices now known or later developed. When the hardware modules or apparatus are activated, they perform the methods and processes included within them.

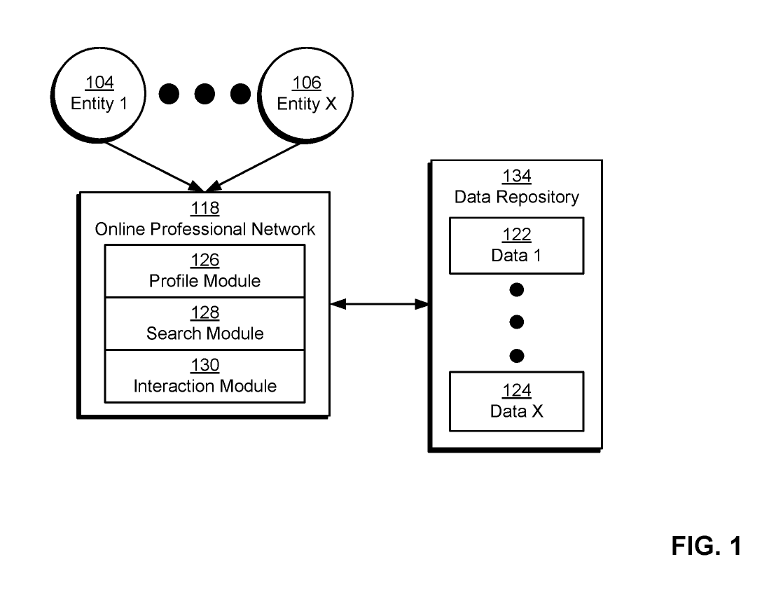

The disclosed embodiments provide a method, apparatus, and system for processing data. As shown in FIG. 1, the data may be associated with a user community, such as an online professional network 118 that is used by a set of entities (e.g., entity 1 104, entity x 106) to interact with one another in a professional and/or business context.

The entities may include users that use online professional network 118 to establish and maintain professional connections, list work and community experience, endorse and/or recommend one another, search and apply for jobs, and/or perform other actions. The entities may also include companies, employers, and/or recruiters that use online professional network 118 to list jobs, search for potential candidates, provide business-related updates to users, advertise, and/or take other action.

More specifically, online professional network 118 includes a profile module 126 that allows the entities to create and edit profiles containing information related to the entities' professional and/or industry backgrounds, experiences, summaries, job titles, projects, skills, and so on. Profile module 126 may also allow the entities to view the profiles of other entities in online professional network 118.

Profile module 126 may also include mechanisms for assisting the entities with profile completion. For example, profile module 126 may suggest industries, skills, companies, schools, publications, patents, certifications, and/or other types of attributes to the entities as potential additions to the entities' profiles. The suggestions may be based on predictions of missing fields, such as predicting an entity's industry based on other information in the entity's profile. The suggestions may also be used to correct existing fields, such as correcting the spelling of a company name in the profile. The suggestions may further be used to clarify existing attributes, such as changing the entity's title of “manager” to “engineering manager” based on the entity's work experience.

Online professional network 118 also includes a search module 128 that allows the entities to search online professional network 118 for people, companies, jobs, and/or other job- or business-related information. For example, the entities may input one or more keywords into a search bar to find profiles, job postings, articles, and/or other information that includes and/or otherwise matches the keyword(s). The entities may additionally use an “Advanced Search” feature in online professional network 118 to search for profiles, jobs, and/or information by categories such as first name, last name, title, company, school, location, interests, relationship, skills, industry, groups, salary, experience level, etc.

Online professional network 118 further includes an interaction module 130 that allows the entities to interact with one another on online professional network 118. For example, interaction module 130 may allow an entity to add other entities as connections, follow other entities, send and receive emails or messages with other entities, join groups, and/or interact with (e.g., create, share, re-share, like, and/or comment on) posts from other entities.

Those skilled in the art will appreciate that online professional network 118 may include other components and/or modules. For example, online professional network 118 may include a homepage, landing page, and/or content feed that provides the latest posts, articles, and/or updates from the entities' connections and/or groups to the entities. Similarly, online professional network 118 may include features or mechanisms for recommending connections, job postings, articles, and/or groups to the entities.

In one or more embodiments, data (e.g., data 1 122, data x 124) related to the entities' profiles and activities on online professional network 118 is aggregated into a data repository 134 for subsequent retrieval and use. For example, each profile update, profile view, connection, follow, post, comment, like, share, search, click, message, interaction with a group, address book interaction, response to a recommendation, purchase, and/or other action performed by an entity in online professional network 118 may be tracked and stored in a database, data warehouse, cloud storage, and/or other data-storage mechanism providing data repository 134.

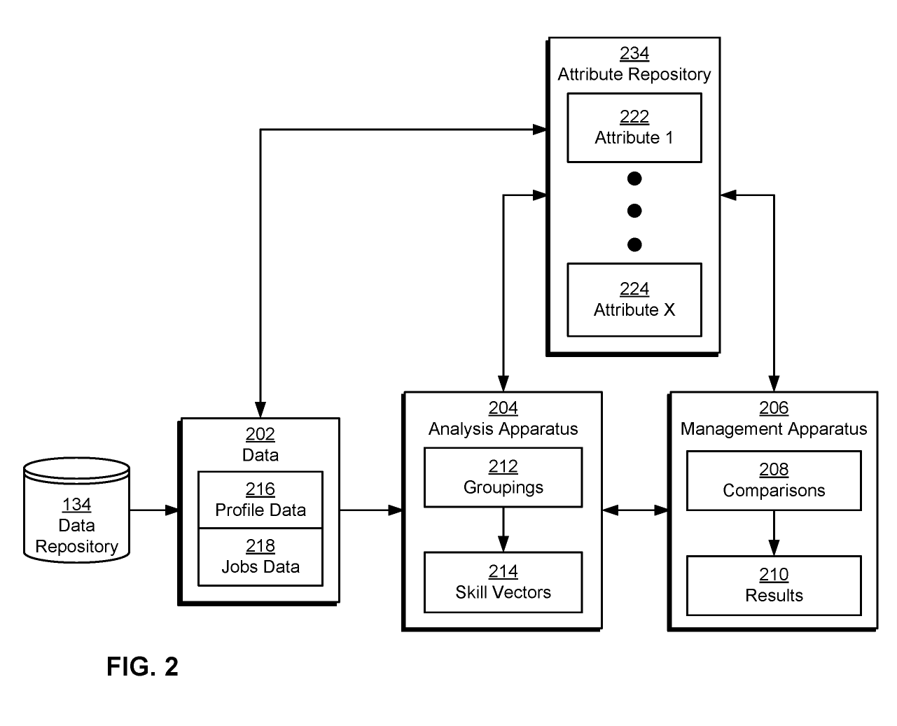

As shown in FIG. 2, data repository 134 and/or another primary data store may be queried for data 202 that includes profile data 216 for members of a social network (e.g., online professional network 118 of FIG. 1), as well as jobs data 218 for jobs that are listed and/or described within and/or outside the social network. Profile data 216 may include data associated with member profiles in the social network. For example, profile data 216 for an online professional network may include a set of attributes for each user, such as demographic (e.g., gender, age range, nationality, location, language), professional (e.g., job title, professional summary, employer, industry, experience, skills, seniority level, professional endorsements), social (e.g., organizations of which the user is a member, geographic area of residence), and/or educational (e.g., degree, university attended, certifications, publications) attributes. Profile data 216 may also include a set of groups to which the user belongs, the user's contacts and/or connections, and/or other data related to the user's interaction with the social network.

Attributes of the members may be matched to a number of member segments, with each member segment containing a group of members that share one or more common attributes. For example, member segments in the social network may be defined to include members with the same industry, title, location, and/or language.

Connection information in profile data 216 may additionally be combined into a graph, with nodes in the graph representing entities (e.g., users, schools, companies, locations, etc.) in the social network. In turn, edges between the nodes in the graph may represent relationships between the corresponding entities, such as connections between pairs of members, education of members at schools, employment of members at companies, following of a member or company by another member, business relationships and/or partnerships between organizations, and/or residence of members at locations.

Jobs data 218 may include structured and/or unstructured data for job listings and/or job descriptions that are posted and/or provided by members of the social network. For example, jobs data 218 for a given job or job listing may include a declared or inferred title, company, required or desired skills, responsibilities, qualifications, role, location, industry, seniority, salary range, and/or member segment (e.g., a group of users that share one or more common attributes in profile data 216).

In one or more embodiments, profile data 216 and jobs data 218 are used to characterize and/or compare skill sets across different groupings 212 of entities (e.g., members, jobs, companies, schools, etc.) in the social network. Groupings 212 may be generated by one or more attributes (e.g., attribute 1 222, attribute x 224) in an attribute repository 234. For example, the attributes may include values of location, time, skills, titles, industries, companies, schools, degrees, summaries, publications, patents, and/or other fields with semantic significance in profile data 216 and/or jobs data 218.

In one or more embodiments, attribute repository 234 stores data that represents standardized, organized, and/or classified attributes in profile data 216 and/or jobs data 218. For example, skills in profile data 216 and/or jobs data 218 may be organized into a hierarchical taxonomy that is stored in attribute repository 234 and/or another repository. The taxonomy may model relationships between skills and/or sets of related skills (e.g., “Java programming” is related to or a subset of “software engineering”) and/or standardize identical or highly related skills (e.g., “Java programming,” “Java development,” “Android development,” and “Java programming language” are standardized to “Java”). In another example, locations in attribute repository 234 may include cities, metropolitan areas, states, countries, continents, and/or other standardized geographical regions. In a third example, attribute repository 234 includes standardized company names for a set of known and/or verified companies associated with the members and/or jobs. In a fourth example, attribute repository 234 includes standardized titles, seniorities, and/or industries for various jobs, members, and/or companies in the social network. In a fifth example, attribute repository 234 includes standardized time periods (e.g., daily, weekly, monthly, quarterly, yearly, etc.) that can be used to retrieve profile data 216, jobs data 218, and/or other data 202 that is represented by the time periods (e.g., starting a job in a given month or year, graduating from university within a five-year span, job listings posted within a two-week period, etc.).

In one or more embodiments, an analysis apparatus 204 generates groupings 212 of entities based on standardized attributes (e.g., from attribute repository 234) shared by the entities. Analysis apparatus 204 and/or another component of the system may obtain one or more attributes and/or attribute types (e.g., categories of attributes) by which groupings 212 are to be made. For example, the component may obtain the attribute types through a user interface, configuration file, and/or another mechanism for interacting with a user. In another example, the component may obtain a list of specific attributes associated with a given grouping of entities (e.g., members that were employed in the software industry in the United States in the year 2000). In a third example, the component may randomly select attributes and/or attribute types for use in grouping the entities. In a fourth example, the component may select attributes and/or attribute types to form cohorts of entities to be compared (e.g., members who graduated 10 years apart from the same school).

Next, analysis apparatus 204 generates groupings 212 of entities by the attributes. For example, analysis apparatus 204 may use attribute repository 234 to generate unique combinations of attribute values for a given set of attribute types. Exemplary combinations generated from attributes in attribute repository 234 may include, but are not limited to, combinations of locations and collections of related skills; titles and/or academic degrees; cities and industries; and/or academic degrees and graduation years. For each unique combination of attribute values, analysis apparatus 204 may query data repository 134 for profile data 216 and/or jobs data 218 that matches the attribute values. Analysis apparatus 204 may then use the retrieved profile data 216 and/or jobs data 218 to produce a grouping of entities by the corresponding attribute values.

Analysis apparatus 204 then generates a set of skill vectors 214 for groupings 212 of the entities. Each skill vector may include a set of scores representing the “representativeness” (e.g., uniqueness, prevalence, importance, etc.) of a set of skills in the corresponding grouping of entities. A higher score may indicate a skill that is more representative of entities in the grouping, and a lower score may represent a skill that is less representative of entities in the grouping.

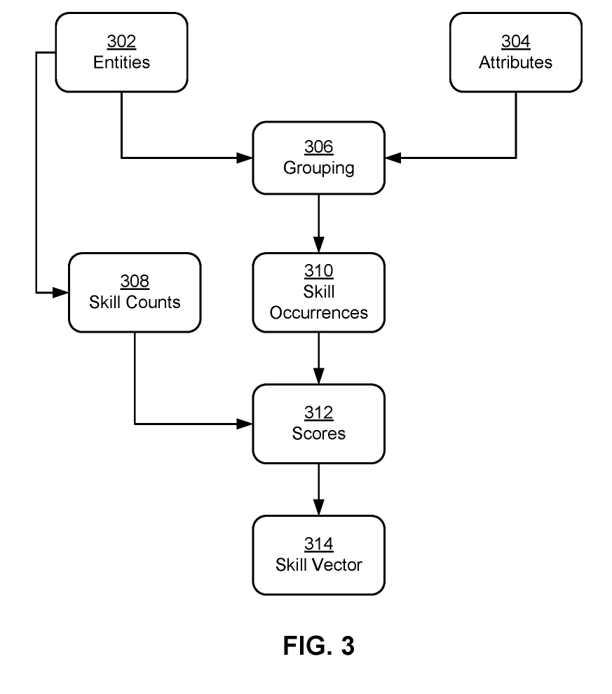

The scores may be calculated from counts of each skill in the grouping, as described in further detail below with respect to FIG. 3. For example, each score may be calculated using a term frequency-inverse document frequency (TF-IDF) calculated from counts of the corresponding skill within the grouping and across multiple groupings of the entities. As a result, the score may be higher when the skill appears frequently within the grouping and infrequently in other groupings. In other words, the score may be proportional to the prevalence or occurrence of the skill within the grouping and inversely proportional to the occurrence of the skill across groupings.

On the other hand, measuring skill representativeness using only TF (i.e., prevalence of a skill within a grouping without considering the occurrence of the skill across groupings 212) may result in highly scored skills that are commonly found across groupings 212 of entities instead of highly scored skills that are unique to individual grouping 212. For example, groupings 212 of entities by university degrees of economics, psychology, and biology may have the same highly scored skills of “Microsoft office,” “customer service,” and/or “management” when only TF is used to measure the representativeness of skills within each grouping. The common occurrence of such skills across groupings 212 may interfere with the identification of skills that are both prevalent in and unique to each grouping.

After the score is calculated using TF-IDF, analysis apparatus 204 stores the score, within a skill vector for the grouping, in an entry or element representing the skill. For example, scores for thousands or tens of thousands of standardized skills in an online professional network may be stored in a vector with a length that is set to the number of standardized skills. Within the vector, each entry or element (e.g., dimension of the vector) represents a different standardized skill and stores a score representing the representativeness of the skill in a corresponding grouping of entities represented by the skill vector.

After skill vectors 214 are calculated for all relevant groupings 212 of entities, a management apparatus 206 performs comparisons 208 of scores within and/or across skill vectors 214 to characterize groupings 212 with respect to the skills. First, management apparatus 206 may sort and/or filter skills in a given grouping of entities by scores in the skill vector for the grouping. In turn, management apparatus 206 may identify a subset of skills with the highest scores as the most common skills in the grouping that are also relatively unique to the grouping (e.g., the top 10 skills in each grouping of entities).

Second, management apparatus 206 may use skill vectors 214 for two groupings of entities to calculate a skill-based similarity between the groupings. For example, management apparatus 206 may use vector operations to calculate the skill-based similarity as a dot product, cosine similarity, squared Euclidean distance, and/or other measure of similarity between two sets of scores for the groupings. In turn, the skill-based similarity may be used to compare the skill sets of entities (e.g., members, companies, organizations, etc.) across attributes such as degree levels (e.g., bachelors degrees, masters degrees, doctorate degrees, etc.), times of graduation or employment (e.g., 2005 graduates versus 2015 graduates), and/or titles (e.g., data scientists versus business analysts).

Third, management apparatus 206 may generate clusters containing multiple groupings 212 of entities based on high skill-based similarities among the groupings. For example, management apparatus 206 applies a clustering technique such as density-based spatial clustering of applications with noise (DBSCAN) to cluster groupings 212 of entities by similarity in various sets of related skills (e.g., skills associated with different industries, companies, titles, educational backgrounds, etc.). Each cluster may identify one or more groupings 212 of entities that have significant overlap in highly scored skills within their respective skill vectors 214.

Fourth, management apparatus 206 may use the clusters to predict a skill trend for a given grouping of entities. For example, management apparatus 206 may apply a collaborative-filtering technique to a cluster of groupings 212 to identify skills that are likely to appear in a grouping within the cluster based on prominent and/or important skills in similar groupings 212 of entities (e.g., from the same cluster). The collaborative-filtering technique may combine skill vectors 214 of groupings 212 within a cluster in a matrix. One dimension of the matrix (e.g., rows) may represent groupings 212, and the other dimension of the matrix (e.g., columns) may represent skills within skill vectors 214. When two or more groupings 212 of entities have skill vectors 214 with similarities (e.g., dot product, cosine similarity, squared Euclidean distance, etc.) that exceed a threshold, management apparatus 206 may identify skills that are likely to appear in a grouping as skills that are already prevalent and/or highly scored in other groupings with similar skill vectors 214.

Finally, management apparatus 206 outputs results 210 associated with comparisons 208. For example, management apparatus 206 may display a set of most common unique skills (e.g., the top 10 skills) for each grouping of entities to allow members in the grouping and/or members that are interested in the grouping (e.g., job seekers interested in jobs in the grouping) to identify and/or develop skills that are important to the grouping. In another example, management apparatus 206 may include, in a table, spreadsheet, data structure, file, database, and/or visualization, pairs or clusters of groupings 212 that have high skill-based similarity with one another. In a third example, management apparatus 206 may combine measures of skill-based similarity among groupings 212 of entities with salary information for the entities to identify and recommend career path transitions (e.g., to different titles, companies, company sizes, industries, seniorities, locations, etc.) that have significant overlap in skills and are associated with salary increases. In a fourth example, management apparatus 206 may recommend courses for learning skills associated with predicted skill trends for a given grouping to allow members in the grouping and/or members that are interested in the grouping to prepare for the skill trends.

By using skill vectors 214 to characterize and compare skill sets in different groupings 212 of entities, the system of FIG. 2 may provide insights that improve understanding and use of skills by various entities in the social network. For example, scores in skill vectors 214 and/or comparisons 208 made using the scores may be used to advance member careers; match members to job postings and/or other opportunities; improve the quality of applicants for the job postings and/or opportunities; and/or track skills-based changes and/or trends along various industries, careers, locations, companies, seniorities, educational backgrounds, times, and/or other attributes. In turn, the system may increase the value of the social network to the members, the value provided by the members to the social network, and/or member engagement with the social network. Consequently, the system may improve technologies that generate or leverage skills-based insights and trends, as well as network-enabled devices and/or applications on which the technologies execute.

Those skilled in the art will appreciate that the system of FIG. 2 may be implemented in a variety of ways. First, analysis apparatus 204, management apparatus 206, data repository 134, and/or attribute repository 234 may be provided by a single physical machine, multiple computer systems, one or more virtual machines, a grid, one or more databases, one or more filesystems, and/or a cloud computing system. Analysis apparatus 204 and management apparatus 206 may additionally be implemented together and/or separately by one or more hardware and/or software components and/or layers.

Second, the generation of groupings 212 and/or skill vectors 214 may be tuned to characterize and/or compare the skill sets of the entities at different granularities. For example, groupings 212 of entities may be generated from different numbers of attributes to assess the skill sets of the entities at multiple levels of specificity. Thus, a general distribution of skills in members, jobs, and/or other entities may be determined by calculating skill vectors 214 for groupings 212 of the entities by a smaller number of attributes (e.g., members with the same title, jobs with the same title and seniority, members or jobs in the same region, members or jobs in the same industry, etc.). Conversely, more specific skill-based assessments of the entities may be performed by generating skill vectors 214 from groupings 212 of the entities by a larger number of attributes (e.g., nurses hired in the United States in 2017, members that graduated with a Bachelor of Arts degree in Economics in 2010, members or jobs in the software industry in Berlin, open job postings for Machine Learning engineers at a specific company, etc.). In another example, scores for individual skills in skill vectors 214 may be aggregated into scores for groups of related skills (e.g., technical skills, industry-based skills, skills associated with a particular field of study, etc.) to characterize and/or compare groupings 212 of entities by the skill groups, in lieu of or in addition to characterization and/or comparison of groupings 212 by the individual skills.

Those skilled in the art will also appreciate that the functionality of the system may be adapted to characterize and/or compare other types of data. For example, vectors of scores may be used to characterize and/or compare connection strengths, educational characteristics, titles, employment histories, interests, preferences, volunteer activities, groups, follows, and/or other types of profile data 216 and/or jobs data 218 for various groupings 212 of entities.

FIG. 3 shows the calculation of a skill vector 314 for a grouping 306 of entities 302 in accordance with the disclosed embodiments. As described above, grouping 306 may be made according to one or more attributes 304 shared by entities 302. For example, grouping 306 may include entities 302 with attributes 304 representing the same location, company, industry, seniority, title, time, education, and/or entity type (e.g., member, job, company, school, etc.).

Next, a set of scores 312 is calculated for grouping 306 based on skill counts 308 and skill occurrences 310 of a set of skills. Skill counts 308 may include counts of each skill within grouping 306. For example, a group of members in a given industry and/or location may have skill counts 308 representing the number of times each skill appears in entities 302 associated with the industry and/or location (e.g., members with profiles that list the industry and/or location, jobs that include the industry and/or location, etc.). In other words, a skill count for a skill may represent the term frequency (TF) of the skill within a given grouping 306 of entities 302.

Skill occurrences 310 may represent the occurrence of the skills across multiple groupings of entities 302. Continuing with the above example, skill occurrences 310 may be calculated as an “IDF” of each skill across various groupings of members by industry and/or location. The IDF may be calculated by applying a logarithm to the total number of groupings of entities 302 by a given set of attributes divided by the number of groupings in which the skill is found:

IDF(s, A)=log(|A|/(1+nₛ))

In the above equation, “A” represents multiple groupings of entities 302 by a set of attributes, and “nₛ” represents the number of groupings in which skill “s” is found. Because certain skills can be found at least once in almost all groupings of entities 302 (e.g., a skill of “C++” in groupings of entities 302 by title), the skill may be deemed to be part of a grouping only when the occurrence of the skill in the grouping exceeds a threshold (e.g., if the skill is included in the top 100 skills for the grouping).

To calculate scores 312, skill counts 308 may be multiplied by skill occurrences 310 for the corresponding skills. For example, each score may be calculated as a TF-IDF of the corresponding skill across groupings of entities 302 by a given set of attributes.

Finally, scores 312 are used to populate skill vector 314 for grouping 306. For example, each score may be stored within skill vector 314 in an entry representing the corresponding skill. In turn, the position of the entry in skill vector 314 may be used to identify the skill and/or retrieve the score for the skill. Skill vector 314 may then be analyzed and/or combined with skill vectors for other groupings of entities 302 to assess and/or compare the skill sets of the groupings, as discussed above.

The calculation of skill vector 314 may be illustrated using an exemplary grouping 306 of members by a geographical region of “Greater Minneapolis Area” and a group of related skills associated with “Web Programming ” First, skill vector 314 may be populated with skill counts 308 for the following truncated list of alphabetically sorted standardized skills in the skill group:

.NET and other Microsoft Application Development: 3729

Account Management: 1779

Accounting: 19763

Administrative and Office Management: 4222

Algorithm: 938

Application Packaging: 52

Within the list, skill counts 308 may be generated by counting the number of times each skill appears in grouping 306 (e.g., in member profiles for members in grouping 306).

Next, skill counts 308 are adjusted by dividing each skill count by a highest skill count of 123,012 in grouping 306 for a standardized skill of “Healthcare Management” to obtain the following representation of skill vector 314:

.NET and other Microsoft Application Development: 0.03031412

Account Management: 0.014462

Accounting: 0.16065912

Administrative and Office Management: 0.0342185

Algorithm: 0.00762527

Application Packaging: 0.000423

Skill occurrences 310 for the skills across multiple groupings of entities 302 are also calculated. For example, the “Account Management” skill may occur at least once in 94 of 336 geographical regions and be included in the top 100 skills in 40 of the 336 geographical regions. As a result, the skill occurrence of the skill across the geographical regions may be calculated as the “IDF” of the skill, which is equal to log(94/(40+1)), or 0.8297227. Values in skill vector 314 are then updated by multiplying skill counts 308 by skill occurrences 310 to obtain the following scores 312:

NET and other Microsoft Application Development: −0.0024899

Account Management: 0.01235656

Accounting: −0.0118264

Administrative and Office Management: 0.00529704

Algorithm: 0.00113904

Application Packaging: 0.000220

Scores 312 in skill vector 314 may then be used to compare grouping 306 with other groupings of entities 302 by geographic region. For example, scores 312 in skill vector 314 may be combined with scores in other skill vectors for the other groupings to generate measures of similarity (e.g., cosine similarity, Euclidean distance, dot product, etc.) between the skill sets of entities 302 in different geographic regions.

The measures may be stored in a distance matrix for the groupings and used to identify and/or cluster groupings of entities 302 that are most similar with respect to one or more skill groups. Continuing with the example, measurements of similarity between groupings of entities 302 by geographic region may be used to generate a first cluster of entities with high similarity in “Java Programming Skills” from the geographic regions of “Dallas/Forth Worth Area,” “Austin, Texas Area,” “San Francisco Bay Area,” and “Greater Seattle Area.” The measurements of similarity may also be used to generate a second cluster of entities with high similarity in “Entertainment Skills” from the geographic regions of “Miami-Fort Lauderdale,” “Los Angeles,” and “New York.”

The clusters may then be used with a collaborative-filtering technique to generate predictions and/or trends for one or more groupings of entities 302. Continuing with the example, the clusters may be used to identify skills that are likely to propagate across groupings in each cluster, compare salaries of jobs with similar skill sets in different geographic regions, and/or identify career path transitions that involve moving from one geographic region to another.

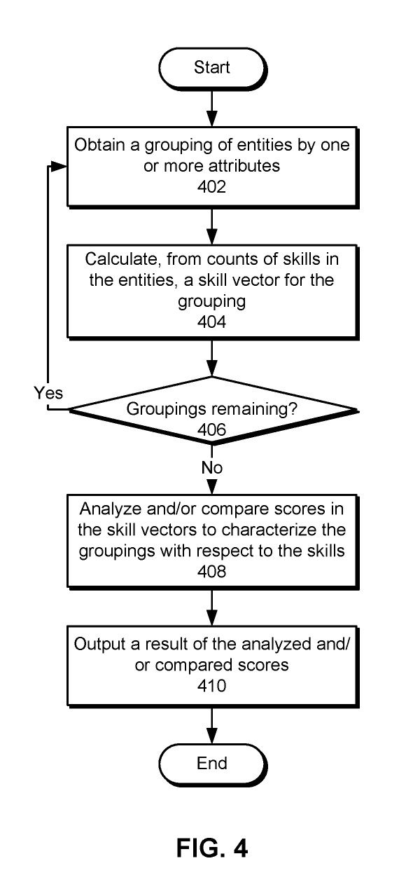

FIG. 4 shows a flowchart illustrating the processing of data in accordance with the disclosed embodiments. In one or more embodiments, one or more of the steps may be omitted, repeated, and/or performed in a different order. Accordingly, the specific arrangement of steps shown in FIG. 4 should not be construed as limiting the scope of the embodiments.

Initially, a grouping of entities by one or more attributes is obtained (operation 402). For example, the entities may include members of an online professional network and/or job listings posted within the online professional network. The attributes may include a location, company, time, industry, title, seniority, education, and/or entity type (e.g., member, job listing, etc.).

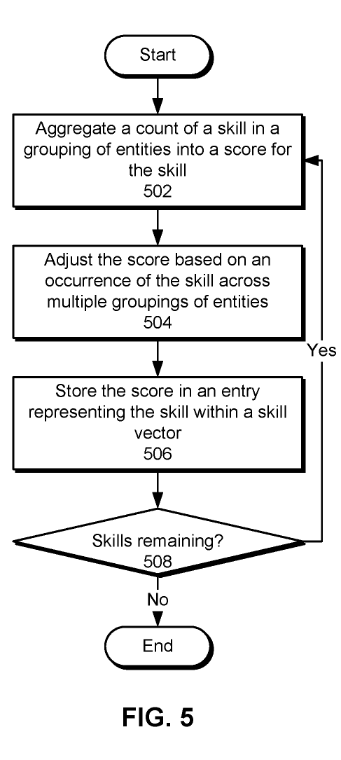

Next, a skill vector for the grouping is calculated from counts of skills in the entities (operation 404), as described in further detail below with respect to FIG. 5. Operations 402-404 may be repeated for remaining groupings (operation 406) of entities. For example, a separate grouping and skill vector may be generated for each unique combination of attribute values associated with the attribute(s).

After the skill vectors are calculated for all relevant groupings of entities, scores in the skill vectors are analyzed and/or compared to characterize the groupings with respect to the skills (operation 408). For example, skills in each grouping may be filtered by the scores to identify a certain number of top skills for the grouping and/or a variable number of top skills in the grouping with scores that exceed a threshold. In another example, a skill-based similarity between two groupings of entities may be calculated as a cosine similarity, dot product, Euclidean distance, and/or another measurement of similarity from scores in the skill vectors of the groupings. In a third example, groupings of entities may be clustered according to high skill-based similarity between and/or among the entities. In a fourth example, a cluster is used to predict a skill trend for a grouping of entities in the cluster.

Finally, a result of the analyzed and/or compared scores is outputted (operation 410). For example, the top skills, skill-based similarities, clusters, skill trends, and/or other results generated from skill vectors for the groupings may be included in a file, table, spreadsheet, visualization, user interface, database, and/or other type of output.

FIG. 5 shows a flowchart illustrating a process of calculating a skill vector for a grouping of entities in accordance with the disclosed embodiments. In one or more embodiments, one or more of the steps may be omitted, repeated, and/or performed in a different order. Accordingly, the specific arrangement of steps shown in FIG. 5 should not be construed as limiting the scope of the embodiments.

First, a count of a skill in a grouping of entities is aggregated into a score for the skill (operation 502). For example, the count may include a TF representing the number of times the skill occurs in a grouping of job postings and/or members. Next, the score is adjusted based on an occurrence of the skill across multiple groupings of the entities (operation 504). Continuing with the previous example, the score may be adjusted by multiplying (e.g., scaling) the TF by an IDF of the skill. The IDF may be calculated by applying a logarithm to the total number of groupings divided by the number of groupings in which the skill is included in a set of top skills (e.g., the top 100 skills in each grouping). The score is then stored in an entry representing the skill within the skill vector (operation 506). Consequently, the score may reflect both the prevalence or frequency of the skill within the grouping (e.g., the TF of the skill) as well as the uniqueness of the skill across groupings (e.g., the IDF of the skill).

Operations 502-506 may be repeated for remaining skills 508 to be characterized using the skill vector. For example, a score may be calculated (operations 502-504) and stored in the skill vector (operation 506) for each skill in a set of related skills and/or all standardized skills identified for all entities.

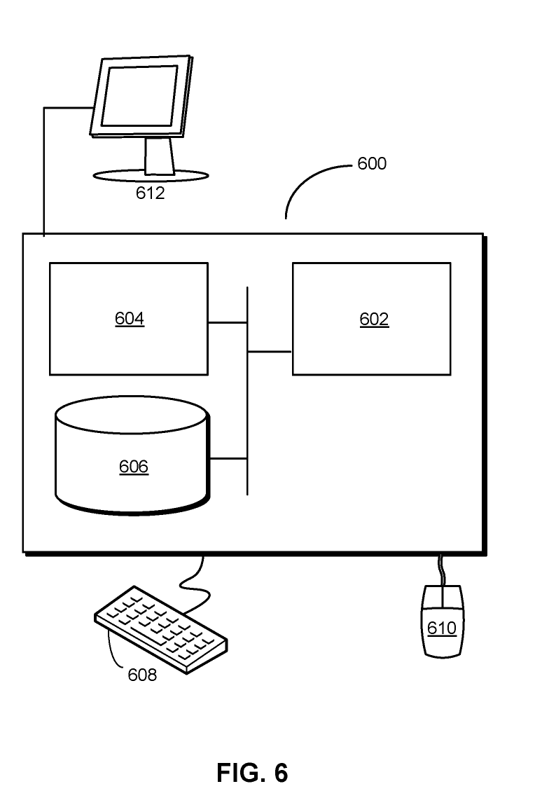

FIG. 6 shows a computer system 600 in accordance with the disclosed embodiments. Computer system 600 includes a processor 602, memory 604, storage 606, and/or other components found in electronic computing devices. Processor 602 may support parallel processing and/or multi-threaded operation with other processors in computer system 600. Computer system 600 may also include input/output (I/O) devices such as a keyboard 608, a mouse 610, and a display 612.

Computer system 600 may include functionality to execute various components of the present embodiments. In particular, computer system 600 may include an operating system (not shown) that coordinates the use of hardware and software resources on computer system 600, as well as one or more applications that perform specialized tasks for the user. To perform tasks for the user, applications may obtain the use of hardware resources on computer system 600 from the operating system, as well as interact with the user through a hardware and/or software framework provided by the operating system.

In one or more embodiments, computer system 600 provides a system for processing data. The system includes an analysis apparatus and a management apparatus, one or more of which may alternatively be termed or implemented as a module, mechanism, or other type of system component. The analysis apparatus obtains a grouping of entities by one or more attributes and calculates, from counts of skills in the entities, a skill vector for the grouping of entities. The analysis apparatus and/or management apparatus then analyzes the set of scores in the skill vector to characterize the grouping with respect to the set of skills. Finally, the management apparatus outputs a result of the analyzed scores.

In addition, one or more components of computer system 600 may be remotely located and connected to the other components over a network. Portions of the present embodiments (e.g., analysis apparatus, management apparatus, data repository, attribute repository, online professional network, etc.) may also be located on different nodes of a distributed system that implements the embodiments. For example, the present embodiments may be implemented using a cloud computing system that characterizes and/or compares the skill sets of multiple groupings of remote entities.

By configuring privacy controls or settings as they desire, members of a social network. a professional network, or other user community that may use or interact with embodiments described herein can control or restrict the information that is collected from them, the information that is provided to them, their interactions with such information and with other members, and/or how such information is used. Implementation of these embodiments is not intended to supersede or interfere with the members' privacy settings.

The foregoing descriptions of various embodiments have been presented only for purposes of illustration and description. They are not intended to be exhaustive or to limit the present invention to the forms disclosed. Accordingly, many modifications and variations will be apparent to practitioners skilled in the art. Additionally, the above disclosure is not intended to limit the present invention.

What is claimed is:

1. A system, comprising:
one or more processors; and
memory storing instructions that, when executed by the one or more processors, cause the system to:
obtain a grouping of entities by one or more attributes;
calculate, from counts of skills in the entities, a skill vector for the grouping of entities, wherein the skill vector comprises a set of scores representing a prevalence of a set of skills in the grouping;
analyze the set of scores in the skill vector to characterize the grouping with respect to the set of skills; and
output a result of the analyzed set of scores.

2. The system of claim 1, wherein calculating the skill vector for the grouping of entities comprises:
aggregating a count of a skill in the grouping into a score for the skill; and
storing the score in an entry representing the skill within the skill vector.

3. The system of claim 2, wherein calculating the skill vector for the grouping of entities further comprises:
adjusting the score based on an occurrence of the skill across multiple groupings of the entities.

4. The system of claim 3, wherein adjusting the score based on the prevalence of the skill across multiple groupings of the entities comprises:
scaling the count of the skill by the occurrence of the skill in a set of top skills across the multiple groupings of the entities.

5. The system of claim 1, wherein analyzing the set of scores to characterize the grouping with respect to the set of skills comprises:
filtering the set of skills by the set of scores.

6. The system of claim 1, wherein analyzing the set of scores to characterize the grouping with respect to the set of skills comprises:
using the skill vector and another skill vector for another grouping of the entities to calculate a skill-based similarity between the grouping and the other grouping.

7. The system of claim 1, wherein analyzing the set of scores to characterize the grouping with respect to the set of skills comprises:
using the set of scores to generate a cluster comprising the grouping of the entities and additional groupings of the entities with high skill-based similarity to the grouping.

8. The system of claim 7, wherein analyzing the set of scores to characterize the grouping with respect to the set of skills further comprises:
using the cluster to predict a skill trend for the grouping of the entities.

9. The system of claim 7, wherein the high skill-based similarity is associated with a set of related skills.

10. The system of claim 1, wherein the set of entities comprises at least one of:
a member of an online professional network; and
a job posting.

11. The system of claim 1, wherein the one or more attributes comprise at least one of:
a location;
a company;
an industry;
a seniority;
a title;
a time;
an education; and
an entity type.

12. A method, comprising:
obtaining a grouping of entities by one or more attributes;
calculating, by one or more computer systems from counts of skills in the entities, a skill vector for the grouping of entities, wherein the skill vector comprises a set of scores representing a prevalence of a set of skills in the grouping;
analyzing, by the one or more computer systems, the skill vector to characterize the grouping with respect to the set of skills; and
outputting a result of the analyzed skill vector.

13. The method of claim 12, wherein calculating the skill vector for the grouping of entities comprises:
aggregating a count of a skill in the grouping into a score for the skill; and
storing the score in an entry representing the skill within the skill vector.

14. The method of claim 13, wherein calculating the skill vector for the grouping of entities further comprises:
adjusting the score based on an occurrence of the skill across multiple groupings of the entities.

15. The method of claim 14, wherein adjusting the score based on the prevalence of the skill across multiple groupings of the entities comprises:
scaling the count of the skill by the occurrence of the skill in a set of top skills across the multiple groupings of the entities.

16. The method of claim 12, wherein analyzing the set of scores to characterize the grouping with respect to the set of skills comprises at least one of:
filtering the set of skills by the set of scores;
using the skill vector and another skill vector for another grouping of the entities to calculate a skill-based similarity between the grouping and the other grouping; and
using the set of scores to generate a cluster comprising the grouping of the entities and additional groupings of the entities with high skill-based similarity to the grouping.

17. The method of claim 16, wherein analyzing the set of scores to characterize the grouping with respect to the set of skills further comprises:
using the cluster to predict a skill trend for the grouping of the entities.

18. The method of claim 12, wherein the one or more attributes comprise at least one of:
a location;
a company;
an industry;
a seniority;
a title;
a time;
an education; and
an entity type.

19. A non-transitory computer-readable storage medium storing instructions that when executed by a computer cause the computer to perform a method, the method comprising:
obtaining a grouping of entities by one or more attributes;
calculating, from counts of skills in the entities, a skill vector for the grouping of entities, wherein the skill vector comprises a set of scores representing a prevalence of a set of skills in the grouping;
analyzing the skill vector to characterize the grouping with respect to the set of skills; and
outputting a result of the analyzed skill vector.

20. The non-transitory computer-readable storage medium of claim 19, wherein calculating the skill vector for the grouping of entities comprises:
aggregating a count of a skill in the grouping into a score for the skill;
adjusting the score based on an occurrence of the skill across multiple groupings of the entities; and
storing the score in an entry representing the skill within the skill vector.
